(19) United States
(12) Patent Application Publication
(10) Pub. No.: US 2026/0037832 A1
(43) Pub. Date: Feb. 5, 2026

(54) GENERATIVE ARTIFICIAL INTELLIGENCE MINI-PLATFORM FRAMEWORK FOR AN ENTERPRISE

(71) Applicants: Milan Digambar Dhore, Rocky Hill, CT (US); Rajesh Kamlakar Nerurkar, Charlotte, NC (US)

(72) Inventors: Milan Digambar Dhore, Rocky Hill, CT (US); Rajesh Kamlakar Nerurkar, Charlotte, NC (US)

(21) Appl. No.: 18/791,626

(22) Filed: Aug. 1, 2024

(51) Int. Cl. G06N 3/10; G06N 3/0475

(52) U.S. Cl. CPC G06N 3/105; G06N 3/0475

(57) ABSTRACT

A generative AI framework for an enterprise may utilize a cloud-based generative AI operational environment to execute LLMs. A mini-platform library data store contains electronic records associated with a plurality of potential generative AI mini-platforms, and a workflow function library data store contains functions usable to customize managed workflows. A plurality of active enterprise mini-platforms may each be based on a potential generative AI mini-platform and have a customized managed workflow for an enterprise use case. An enterprise application integration component coupled to the cloud-based generative AI operational environment and the active enterprise mini-platforms facilitates model routing and orchestration to support the LLMs. The integration component may also interface between the cloud-based generative AI operational environment and the active enterprise mini-platforms to provide access to enterprise data that is processed via customized managed workflows.

### TECHNICAL FIELD

The present application generally relates to computer systems and more particularly to computer systems that are adapted to accurately, securely, and/or automatically implement a generative Artificial Intelligence (“AI”) framework for an enterprise.

### BACKGROUND

Generative AI is capable of generating text, images, videos, or other data using generative models (e.g., in response to prompts). As used herein, the phrase “generative model” may refer to a model that focuses on understanding how the data is generated by learning about the distribution of the data itself. By way of example, a Large Language Model (“LLM”) is a generative model able to achieve general-purpose language generation and other Natural Language Processing (“NLP”) tasks. Based on language models, LLMs acquire these abilities by learning statistical relationships from vast amounts of text during a training process.

An enterprise, such as a business, might consider implementing generative AI for various reasons. FIG. 1 are some factors 100 to consider when strategically channeling generative AI for an enterprise. The factors 100 may include enhancing a product or service offering 110. That is, an enterprise may use generative AI to create personalized customer products and services, enhancing customer experience and engagement. Another factor 100 might be improving operational efficiency 120. For example, an enterprise (such as an insurer) might leverage generative AI to automate content generation tasks (such as policy documentation, reducing manual effort and improving efficiency, hyper-automation, etc.). Automating content generation can significantly reduce time and costs. Still another factor 100 might be an enterprise's desire to drive innovation 130. For example, an enterprise may explore new business models and opportunities enabled by generative AI (such as AI-driven risk assessment, personalized marketing, etc.). In this way, generative AI may open new avenues for business growth and differentiation (such as in the insurance sector).

Typically, generative AI models are implemented and trained from scratch by an enterprise on a case-by-case basis. Such traditional approaches to generative AI models, however, are labor-intensive, time consuming, and expensive. It would be desirable to provide improved systems and methods to accurately and/or automatically implement generative AI models for an enterprise. Moreover, model workflows should be easy to access, understand, interpret, update, etc.

### SUMMARY OF THE INVENTION

According to some embodiments, systems, methods, apparatus, computer program code and means are provided to accurately and/or automatically implement generative AI models for an enterprise in a way that provides fast, secure, and useful results and that allows for flexibility and effectiveness customizing workflows.

Some embodiments are directed to a generative AI framework for an enterprise that utilizes a cloud-based generative AI operational environment to execute LLMs. A mini-platform library data store may contain electronic records associated with a plurality of potential generative AI mini-platforms (and, for each potential generative AI mini-platform, a mini-platform identifier and at least one mini-platform parameter). A workflow function library data store may contain functions usable to customize managed workflows for the enterprise. A plurality of active enterprise mini-platforms may each be based on a potential generative AI mini-platform and have a customized managed workflow for an enterprise use case. An enterprise application integration component coupled to the cloud-based generative AI operational environment and the plurality of active enterprise mini-platforms, may facilitate model routing and orchestration to support the LLMs. The integration component may also interface between the cloud-based generative AI operational environment and the plurality of active enterprise mini-platforms to provide access to enterprise data that is processed via customized managed workflows.

Some embodiments comprise: means for facilitating, by a computer processor of an enterprise application integration component, model routing and orchestration to support LLMs; means for interfacing, by the enterprise application integration component, between a cloud-based generative AI operational environment and a plurality of active enterprise mini-platforms providing access to enterprise data that is processed via customized managed workflows; and means for executing the LLMs in a cloud-based generative AI operational environment. Moreover, a mini-platform library data store may contain electronic records associated with a plurality of potential generative AI mini-platforms (and for each potential generative AI mini-platform the record might include a mini-platform identifier and at least one mini-platform parameter). Further, a workflow function library data store that may contain functions usable to customize managed workflows for the enterprise. In addition, each of the plurality of active enterprise mini-platforms may be based on a potential generative AI mini-platform and has a customized managed workflow associated with an enterprise use case.

In some embodiments, a communication device associated with a back-end application computer server or framework exchanges information with remote devices in connection with interactive graphical user interfaces. The information may be exchanged, for example, via public and/or proprietary communication networks.

A technical effect of some embodiments of the invention is improved and computerized ways to implement generative AI models for an enterprise that provides fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 are some factors to consider when strategically channeling generative AI for an enterprise.

FIG. 2 describes generative AI platform as a product aspects in accordance with some embodiments.

FIG. 3 describes use case management according to some embodiments.

FIG. 4 illustrates generative AI business strategy aspects in accordance with some embodiments.

FIG. 5 is a high-level block diagram of a generative AI mini-platform system in accordance with some embodiments.

FIG. 6 illustrates a high-level method according to some embodiments.

FIG. 7 is a generative AI platform architecture according to some embodiments.

FIG. 8A is a more detailed generative AI platform architecture in accordance with some embodiments.

FIG. 8B illustrates features of a platform according to some embodiments.

FIG. 9 is an example of a workflow modification in accordance with some embodiments.

FIG. 10 is an example of a workflow extension according to some embodiments.

FIGS. 11A and 11B are an example of a JSON schema to validate a workflow in accordance with some embodiments.

FIG. 12 is a workflow validation method according to some embodiments.

FIG. 13 is a conceptual view of an enterprise reference architecture according to some embodiments.

FIGS. 14 and 15 are some RAG frameworks in accordance with various embodiments.

FIG. 16 through 18 are some text summarization frameworks according to various embodiments.

FIGS. 19 through 21 are some entity extraction frameworks in accordance with various embodiments.

FIG. 22 is a data augmentation framework according to some embodiments.

FIG. 23 is a block diagram of an apparatus in accordance with some embodiments.

FIG. 24 is a portion of a mini-platform library database according to some embodiments.

FIG. 25 is an operator or administrator display in accordance with some embodiments.

FIG. 26 illustrates a handheld tablet displaying a workflow customization UI according to some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with implementing generative AI models for an enterprise. The present invention is directed to more than merely a computer implementation of a routine or conventional activity previously known in the industry as it provides a specific advancement in the area of electronic record analysis by providing improvements in the operation of a computer system that customizes models based on use cases (including those associated with risk relationships). The present invention provides improvement beyond a mere generic computer implementation as it involves the novel ordered combination of system elements and processes to provide improvements in the speed, security, and accuracy of such generative AI models for an enterprise. Some embodiments of the present invention are directed to a system adapted to automatically customize and execute implement generative AI models for an enterprise, aggregate data from multiple data sources, automatically generate LLM information to reduce unnecessary messages or communications, etc. (e.g., to consolidate communications between parties). Moreover, communication links and messages may be automatically established, aggregated, formatted, modified, removed, exchanged, etc. to improve network performance (e.g., by reducing an amount of network messaging bandwidth and/or storage required to create generative AI models messages or alerts, improve security, reduce the size of data stores, more efficiently collect, present, utilize previously created information by the enterprise, etc.).

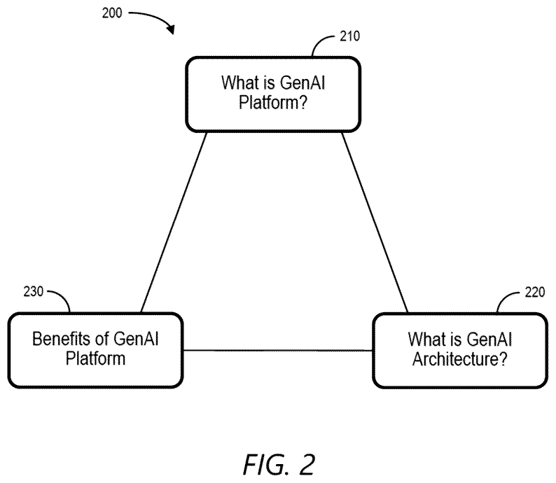

FIG. 2 describes generative AI platform as a product aspects 200 in accordance with some embodiments. A first aspect 210 to be considered might be “what is a generative AI (“GenAI”) platform?” An AI platform may be a centralized AI intelligence framework designed to enhance business capabilities across various lines of business. It may offer real-time, near real-time, and batch processing interfaces through an enterprise facade layer to integrate enterprise applications. According to some embodiments an AI framework may include “mini-platforms,” each dedicated to a specific GenAI capability such as text Summarization, RAG and chatbot Question-Answer (“QA”) systems, data extraction, etc.

A second aspect 220 to consider might be “what is a generative AI architecture?” Such an architecture might include an enterprise facade layer that serves as a unified interfacing layer to connect consuming applications with GenAI services. The GenAI mini-platforms may be built on a generic data pipeline with customizable stages to cater to the unique needs of enterprise use case requirements. A foundational layer may include components such as enterprise application integration, model orchestration and routing, prompt management, core data and AI foundation services, Responsible AI (“RAI”) services, LLM and ML Ops, GenAI Ops, security, etc. A third aspect 230 to consider might be the benefits of a generative AI platform. Such benefits might include scalability (to enable development and deployment of GenAI applications across an enterprise efficiently); innovation (supporting an enterprise's drive toward digital transformation by leveraging advanced AI technologies); a competitive advantage (providing a technological edge by centralizing AI capabilities which may lead to faster and more innovative solutions); cost savings (by reducing operational costs through automation and improved process efficiencies); improved customer satisfaction (better customer experiences by providing sophisticated, AI-driven interactions and services); etc.

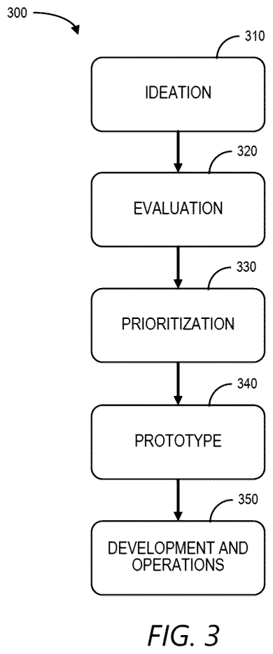

FIG. 3 describes use case management 300 according to some embodiments. During ideation 310, use case ideas may be collected and potential use cases may be identified. This stage might, for example, involve brainstorming sessions and collaborative efforts to capture a diverse range of ideas. During evaluation 320, use cases are compared based on estimated business impact and evaluated based on estimated implementation complexity. During prioritization 330, use cases may be assessed and ranked based on potential impact and feasibility. The goal is to narrow down on a strategic GenAI use case portfolio, including a handful of use cases to be implemented within in the near future. Creating a prototype 340 may be done to prove concept implementation and allow stakeholders to provide feedback early in the development cycle (helping to identify and address potential issues) as well as testing the practical feasibility and effectiveness of GenAI solutions. Development and operations considerations 350 may be evaluated when the actual AI product is implemented. Depending on the nature of the use case this might include the development or fine-tuning of a foundational or domain-specific AI model. When the solution is ready to deploy, it may be integrated into existing systems and a monitoring mechanism can be established to track model performance over time.

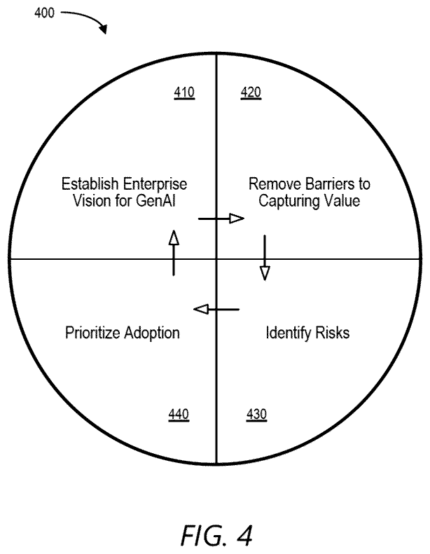

FIG. 4 illustrates generative AI business strategy aspects 400 in accordance with some embodiments. Establishing an enterprise vision for generative AI 410 might involve how GenAI will drive enterprise goals, what benefits are expected, how an enterprise will measure success (e.g., using Key Performance Indicator (“KPI”) values), etc. When removing barriers to capturing value 420, various organizational barriers that could hinder success can be considered along with what actions might help to remove those hurdles. Other factors such as business impact and change management considerations may also be important. When identifying risks 430 an enterprise might consider the various regulatory, reputational, competency, technology, and other risks may need to be assessed and mitigated. When prioritizing adaptation 440 the enterprise might evaluate which are the best GenAI initiatives to pursue (based on their value and feasibility in the opinion of Information Technology (“IT”) and business leaders). According to some embodiments, the cycle of the generative AI business strategy aspects 400 may be executed continuously and repeatedly to improve the framework's performance.

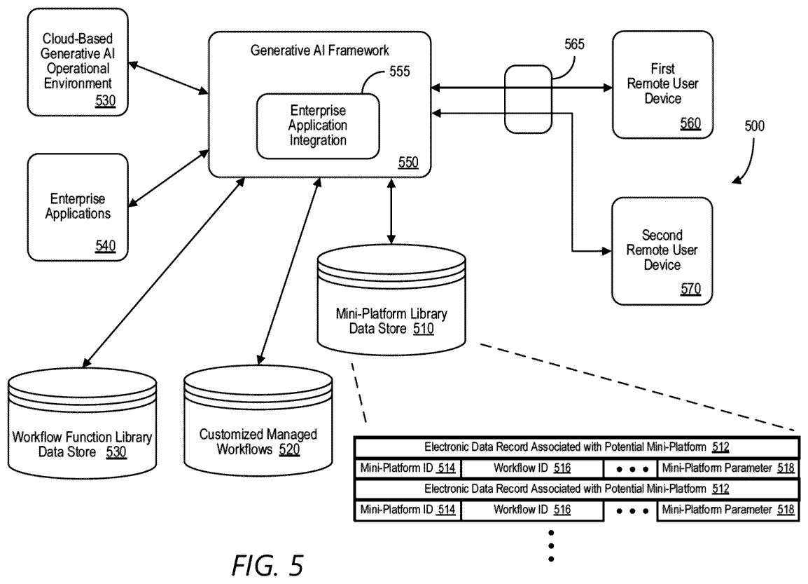

FIG. 5 is a high-level block diagram of a generative AI mini-platform system 500 that may be provided according to some embodiments of the present invention. In particular, the system 500 includes a generative AI framework 550 that may access information in a mini-platform library data store 510 (e.g., storing a set of electronic records associated with potential mini-platforms 512, each record including, for example, one or more mini-platform identifiers 514, workflow identifiers 516, mini-platform parameters 518, etc.). The generative AI framework 550 may also store information into other data stores, such as a customized managed workflows data store 520 and a workflow function library 530 (containing functions that are usable to customize managed workflows for the enterprise), and utilize enterprise application integration 555 to exchange and process messages and view, analyze, and/or update the electronic records. The generative AI framework 550 may also exchange information with a first remote user device 560 and a second remote user device 570 (e.g., via a firewall 565). According to some embodiments, an interactive graphical user interface platform of the generative AI framework 550 may facilitate the creation and review of mini-platform analysis, recommendations, alerts, and/or the display of results via one or more remote administrator computers (e.g., to summarize system 500 performance) and/or the remote user devices 560, 570. For example, the first remote user device 560 may transmit annotated and/or updated information to the generative AI framework 550. Based on the updated information, the generative AI framework 550 may adjust data in the mini-platform library data store 510 and/or the customized managed workflows data store 520 and the change may (or may not) be used in connection with the second remote user device 570. Note that the generative AI framework 550 and/or any of the other devices and methods described herein might be associated with a third party, such as a vendor that performs a service for an enterprise. In some cases, an ingestion engine may exchange information with a cloud-based generative AI operational environment 530 and/or enterprise application 540.

The generative AI framework 550 and/or the other elements of the system 500 might be, for example, associated with a Personal Computer (“PC”), laptop computer, smartphone, an enterprise server, a server farm, and/or a database or similar storage devices. According to some embodiments, an “automated” generative AI framework 550 (and/or other elements of the system 500) may facilitate the automated access and/or update of electronic records in the data stores 510, 520 and/or the management of GenAI mini-platforms. As used herein, the term “automated” may refer to, for example, actions that can be performed with little (or no) intervention by a human.

Devices, including those associated with the generative AI framework 550 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The generative AI framework 550 may store information into and/or retrieve information from the mini-platform library data store 510 and/or the customized managed workflows data store 520. The data stores 510, 520 may be locally stored or reside remote from the generative AI framework 550. As will be described further below, the mini-platform library data store 510 may be used by the generative AI framework 550 in connection with an interactive user interface to access and update electronic records. Although a single generative AI framework 550 is shown in FIG. 5, any number of such devices may be included. Moreover, various devices described herein might be combined according to embodiments of the present invention. For example, in some embodiments, the generative AI framework 550 and mini-platform library data store 510 might be co-located and/or may comprise a single apparatus.

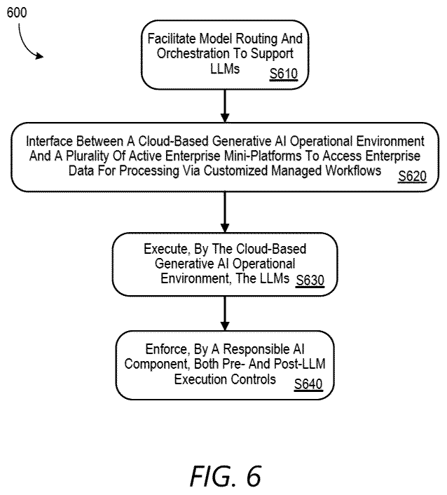

The elements of the system 500 may work together to perform the various embodiments of the present invention. Note that the system 500 of FIG. 5 is provided only as an example, and embodiments may be associated with additional or fewer elements or components. According to some embodiments, the elements of the system 500 automatically transmit information associated with an interactive user interface display over a distributed communication network. FIG. 6 illustrates a high-level method 600 that might be performed by some or all of the elements of the system 500 described with respect to FIG. 5, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S610, a computer processor of an enterprise application integration component may facilitate model routing and orchestration to support LLMs. At S620, an enterprise application integration component may act as an interface between a cloud-based generative AI operational environment and a plurality of active enterprise mini-platforms providing access to enterprise data that is processed via customized managed workflows. According to some embodiments, such a customized managed workflow comprises a series of Python framework stages.

The managed workflows can be “customized” by a user. For example, a managed workflow might comprise a series of components that each perform a function. The components are “wired together” to define the operation of a Gmini-platform. In some cases, a pre-dined workflow may be stored in a library. A user may then access the pre-fined workflow along with a library of functions or components. The user might then utilize a User Interface (“UI”), such as via drag-and-drop operations, to replace components in the workflow, delete components from the workflow, extend the workflow with new, additional functions, etc. According to some embodiments, a function itself can also be modified and stored by a user via the UI (e.g., for easy access and/or reuse by other users).

At S630, the system may execute the LLMs in a cloud-based generative AI operational environment. Moreover, according to some embodiments, a mini-platform library data store contains electronic records associated with a plurality of potential generative AI mini-platforms, and, for each potential generative AI mini-platform, a mini-platform identifier and at least one mini-platform parameter. According to some embodiments, the mini-platform library data store includes both pre-trained foundational models and customized models. Moreover, in some embodiments, each of the plurality of active enterprise mini-platforms is based on a potential generative AI mini-platform and has a customized managed workflow associated with an enterprise use case. At S640, a responsible AI component may enforce both pre-and post-LLM execution controls. At least one active enterprise mini-platform might be associated with, by way of example only, Retrieval-Augmented Generation (“RAG”), summarization, stylization, data extraction, an AI assistant, data augmentation, translation, classification, etc. In some embodiments, a security component may enforce data encryption, authentication, and authorizations. Moreover, a prompt management component may engineer prompt management between the plurality of active enterprise mini-platforms and the enterprise application integration component. In addition, a core data and AI foundation component coupled between the enterprise application integration component and a plurality of business applications may acquire, curate, disseminate, manage, and/or govern domain data for workflow consumption.

According to some embodiments, the enterprise is associated with risk relationships. For example, an enterprise may enter into risk relationships with various customers (e.g., people or businesses). Moreover, the enterprise may perform a risk analysis to determine, for example, the likelihood and/or magnitude of various occurrences. For example, an insurer may perform “underwriting” which is a complex process involving the evaluation of risk, verification of data consistency, identification of missing information, generation of recommendations, etc. In some embodiments, the enterprise comprises an insurer and at least one use case is associated with at least one of: regulation/compliance filing assistance, an enhanced customer-facing chatbot, personalized marketing communications creation, insurance policy summarization, personalized messages and recommendations, competitive intelligence report generation, data augmentation for actuarial pricing, an agent recommendation generation engine, a voice input for claims First Notice of Loss (“FNOL”), product summarization for product design, a conversational solution configuration, a knowledge worker conversational User Interface (“UI”) for core systems, code generation, underwriting risk analysis and summary, fraud rule generation, a knowledge worker chatbot, legacy code conversion assistance, etc.

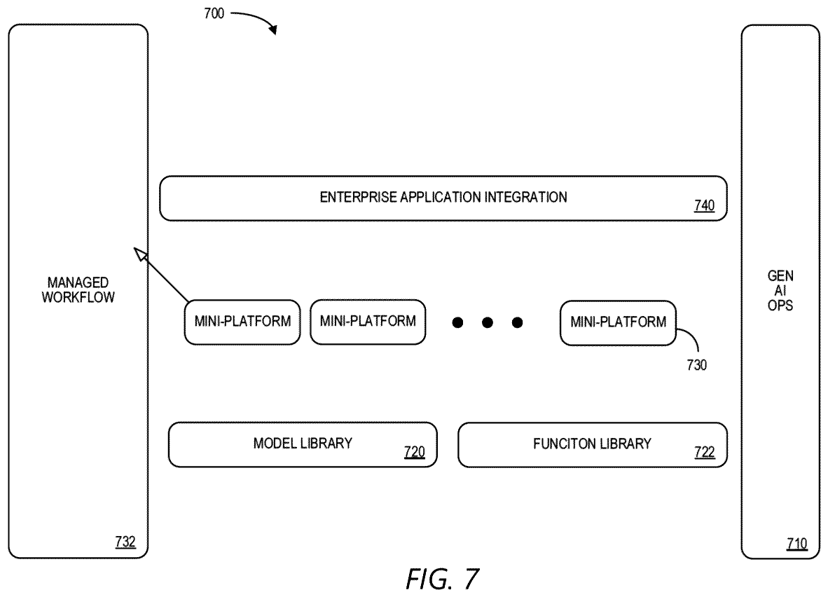

FIG. 7 is a generative AI platform architecture 700 associated with infrastructure that enables full-stack and end-user application integration patterns according to some embodiments. The architecture 700 includes generative AI operations 710 that provide capabilities across model ops, dev/sec ops, and platform ops for end-to-end observability. The generative AI operations 710 may be associated with a cloud computing environment such as AMAZON Web Services (“AWS”), MICROSOFT AZURE, etc. A model library 720 may store, for example, pre-trained foundation AI models and/or customized AI models, etc. A function library 730 may store, for example, pre-defined functions or components and/or previously customized functions that might be used to replace components in a workflow or extend a workflow by adding new components. The models may be used to establish mini-platforms 730 with customized managed workflows 732. According to some embodiments, a Python framework such as LangChain may be used to implement the customized managed workflows 732, such as by using RAI client stages, document loader stages, etc. The mini-platforms 730 may interact with an enterprise application integration layer 740 providing model routing and orchestration capabilities among other functions.

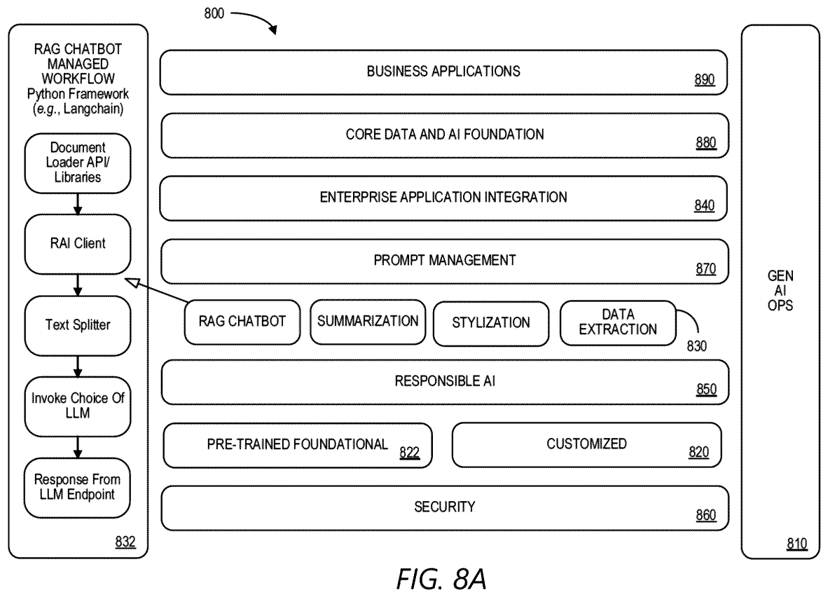

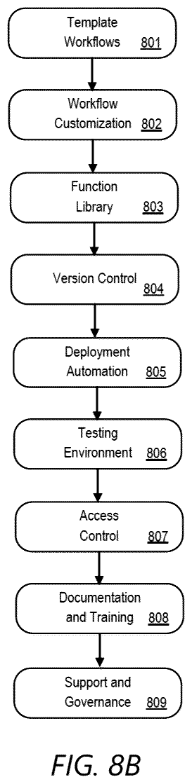

FIG. 8A is a more detailed generative AI platform architecture 800 in accordance with some embodiments. As before, the architecture 800 includes generative AI operations 810 that provide capabilities across model ops, dev/sec ops, and platform ops for end-to-end observability. A customized model library 820 may provide capabilities to manage, customize pre-trained models for tasks and proprietary data, manage and pre-train own models while a pre-trained foundational model library 822 may provide capabilities required to enable foundation model endpoints to make them accessible as a service. The libraries 820, 822 may store, for example, model used to establish mini-platforms 830 (such as those associated with RAG chatbots, summarization, stylization, data extraction, AI assistants, data augmentation, translation, classification, etc.), each with a customizable managed workflow 832. The workflow 832 may be associated with multiple components (e.g., an RAI client, a text splitter, etc.) that are wired together to perform functions. The workflow 832 may be customized, for example, via a UI that can access functions in a function library (e.g., functions that can replace various components within-or be added to extend-the workflow 832). The mini-platforms 830 may interact with a responsible AI 850 layer providing capabilities that enforce responsible AI controls both pre-and post-LLM execution. Moreover, a security 860 layer may provide capabilities that enforce data encryption (in transit and at rest), authentication, and appropriate authorizations to invoke a GenAI workflow.

The mini-platforms 830 may also interact with a prompt management 870 layer that provides capabilities that enable efficient prompt engineering, templatization, and/or prompt reuse in connection with different domains and functions.

The mini-platforms 830 may interact with an enterprise application integration layer 840 that provides model routing and orchestration capabilities, API management, etc. The enterprise application integration layer 840 may enable full-stack end-user application integration patterns. The integration pattern might, for example, be deployed in connection with a particular tenant of a multi-tenant environment. In some embodiments, the enterprise application integration layer 840 is associated with a “façade” that provides a simple interface to a complex subsystem which contains many moving parts. A core data and AI foundation 880 may provide capabilities (including infrastructure) for acquiring, curating, disseminating, managing, and governing domain data for GenAI workflow consumption. Finally, enterprise business applications 890 may include chatbots, knowledge bots, and other end user applications, including custom and Software-as-a-Service (“SaaS”) applications.

FIG. 8B illustrates features of a platform to enable application teams to customize and integrate GenAI capabilities with their applications. The features include template workflows 801 such as default workflows for each GenAI capability representing templates that can be cloned. Workflow customization 802 may provide an ability for teams to modify the cloned workflows by adding, removing, or replacing steps. A function library 803 may provide an ability to maintain a library of reusable functions that teams can use to replace or add new steps in a workflow. According to some embodiments, version control 804 may use a repository (e.g., GitHub) to manage changes to the workflows and functions.

In some embodiments, deployment automation 805 may include Continuous Integration/Continuous Delivery (“CI/CD”) pipelines to automate the deployment of customized workflows into a team's tenant (e.g., AWS account). A testing environment 806 may include a sandbox environment where teams can test customized workflows without affecting production systems. Access control 807 may incorporate an Identity and Access Management (“IAM”) feature to control which teams can clone, modify, and deploy workflows. Such an approach may help ensure that permissions are granted based on the principle of least privilege. According to some embodiments, documentation and training 808 may provide comprehensive documentation and training materials to guide application teams through the process of customizing and deploying workflows. Finally, support and governance 809 may allow for the establishment of a support structure for teams to get help when needed and a governance model to ensure that customizations adhere to organizational standards and best practices.

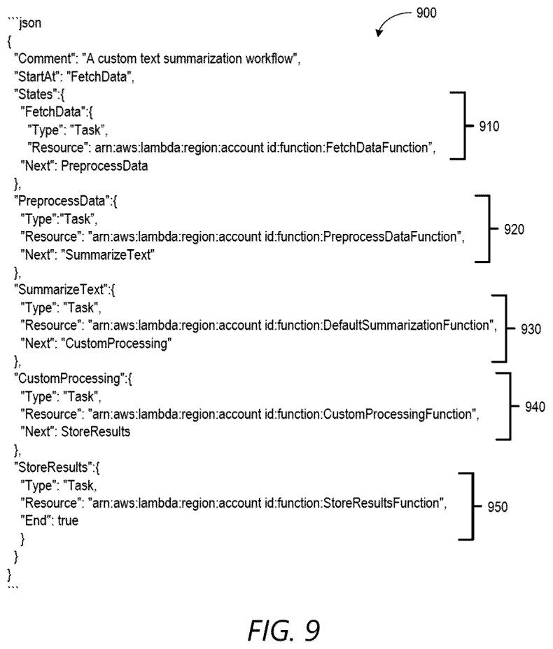

An example of a customized workflow for a text summarization GenAI capability (which an application team can clone and modify according to specific needs) will now be provided. In particular, FIG. 9 is an example of a workflow 900 modification in accordance with some embodiments. In the workflow, FetchData 910 retrieves the data to be summarized (which could be from a database or an API). PreprocessData 920 processes the data to prepare it for summarization, such as cleaning and tokenization. SummarizeText 940 uses a default Lambda function to summarize the text (can be replaced with a custom summarization function if needed). CustomProcessing 940 may comprise an optional step where the summarized text can undergo additional processing, such as sentiment analysis and/or keyword extraction. StoreResults 950 saves the summarized text to a database or sends it to another application. Application teams can clone this default workflow 900 and modify it by replacing the “Resource” AMAZON Resource Name (“ARN”) in SummarizeText 930 with a custom Lambda function. The team can also add or remove states as needed for a use case. This flexibility lets teams tailor the GenAI capabilities to specific application requirements while maintaining a standardized approach to the workflow 900 management.

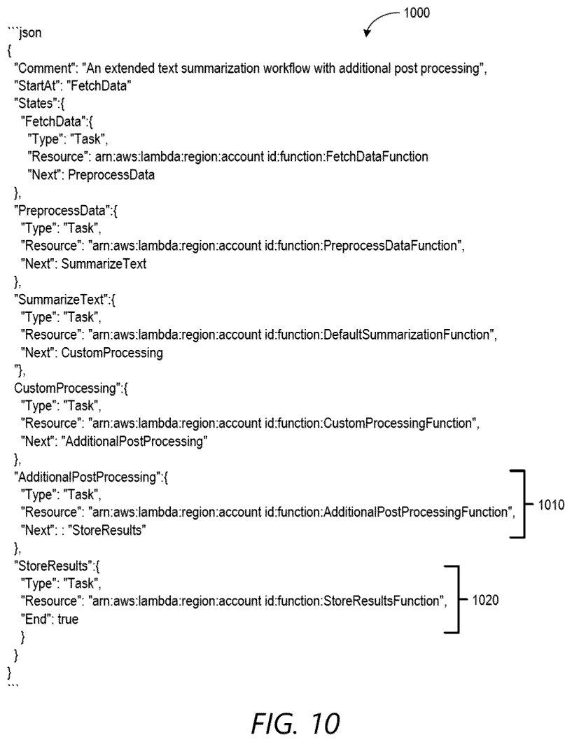

If a team needs to add more steps for post-processing in the customized workflow, this may be done by extending the JSON definition of the AWS Step Functions state machine. FIG. 10 is an example of a workflow extension that modifies the example workflow 900 of FIG. 9 to include additional post-processing steps. In this updated workflow 1000, a new AdditionalPostProcessing 1010 state has been added after the CustomProcessing state. The AdditionalPostProcessing 1010 state is linked to a new Lambda function (“AdditionalPostProcessingFunction”) that performs the extra steps required. StoreResults 1020 remains the final step, ensuring that the processed data is stored or forwarded as needed. This approach maintains the flexibility and modularity of the GenAI workflows, allowing application teams to tailor the GenAI capabilities to evolving requirements. An update to the IAM permissions and the deployment pipeline to accommodate the new Lambda function may be required to ensure it is properly integrated into the workflow 1000.

Some embodiments may provide a low code or no code tool for workflow modifications and/or extensions. For example, AWS provides a low code visual tool called AWS Step Functions Workflow Studio. This tool is designed to help teams build state machines for AWS Step Functions with a guided interactive interface. It lets teams prototype and build workflows faster without the need to write extensive Amazon State Language (“ASL”) code. The Workflow Studio offers a drag-and-drop interface that simplifies the process of creating, editing, and customizing workflows. Teams might use it to: drag-and-drop flow and task states onto a canvas; configure states and data transformations using built-in forms; prototype new workflows and share them with stakeholders quickly; start from an existing workflow, an example workflow, or build a new workflow from scratch; etc. Such an approach may be particularly useful for developers who are new to Step Functions (as it provides an accelerated learning path and reduces the time to build the first workflow). Experienced developers can also benefit from Workflow Studio to develop workflows more efficiently. To integrate Workflow Studio into a platform, access to this tool may be provided to application teams, letting them visually customize Step Function workflows as per requirements. This may be a powerful addition to the GenAI platform, enabling application teams to tailor the GenAI capabilities with ease and precision.

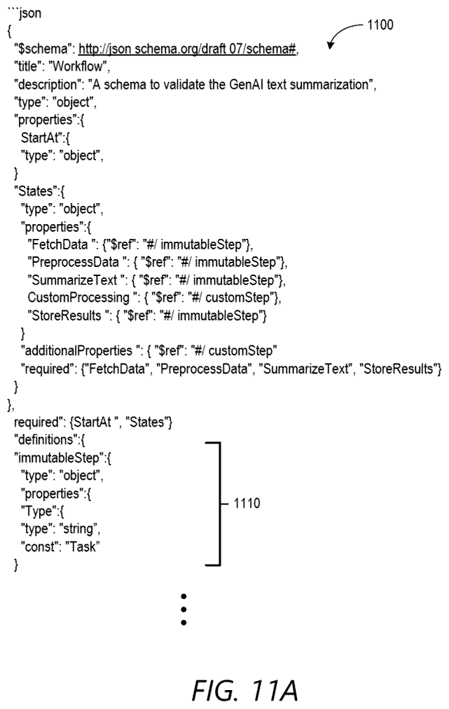

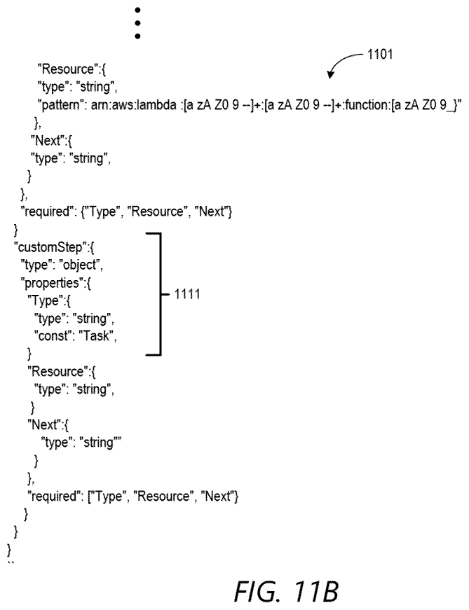

An example of a JSON schema that could be used to validate a workflow for a text summarization GenAI capability will now be provided. This schema may ensure that certain steps, such as SummarizeText, are not removed or altered, while allowing for additional custom steps. In particular, FIGS. 11A and 11B are an example of a JSON schema to validate a workflow in accordance with some embodiments. FIG. 11A is an initial portion of the schema 1100 where “properties” within “States” defines which steps must be present in the workflow. The “immutableStep” definition 1110 ensures that certain steps cannot be altered. It uses the “const” keyword to enforce that the “Type” must be “Task” and the “Resource” must match a specific pattern (indicating the ARN of the Lambda function). The schema 1101 continues in FIG. 11B where a customStep definition 1111 allows for additional properties (or steps) to be added to the workflow. The “required” array within “States” may help ensure that the specified steps are present and not removed. This schema 1101 can be used in conjunction with a validation tool to check the integrity of the workflow before it's deployed. If the workflow JSON does not conform to this schema 1101, the tool can reject the changes and notify the team to make the necessary corrections.

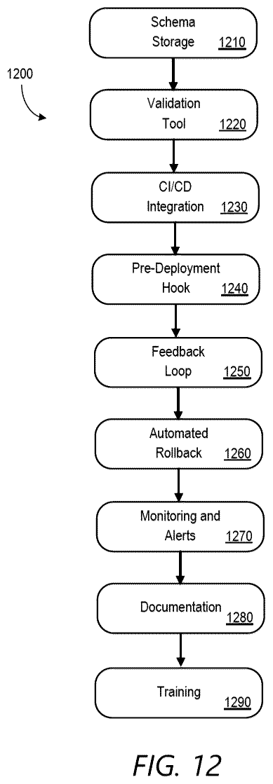

Validating a workflow using a JSON schema and validation tool may involve integrating the JSON schema into a validation process using a method to help ensure that the workflow modifications adhere to the defined structure and rules. FIG. 12 is such a workflow validation method 1200 according to some embodiments. At 1210, schema storage 1210 may store the JSON schema in a central repository where it can be accessed by the validation tool. This could be an S3 bucket, an artifact repository, or a version controlled directory. A validation tool 1220 may use a JSON schema validation tool that can compare the customized workflow JSON against the schema. There are many libraries available for this purpose in different programming languages (e.g., JavaScript or Python). According to some embodiments, CI/CD integration 1230 integrates the validation tool into a CI/CD pipeline. The integration 1230 may configure the pipeline to run the validation tool as a step that must pass before the workflow can be deployed. A pre-deployment hook 1240 may set up a pre-deployment hook that triggers the validation tool. If the validation fails, the deployment is halted, and the team is notified about the issues that need to be addressed.

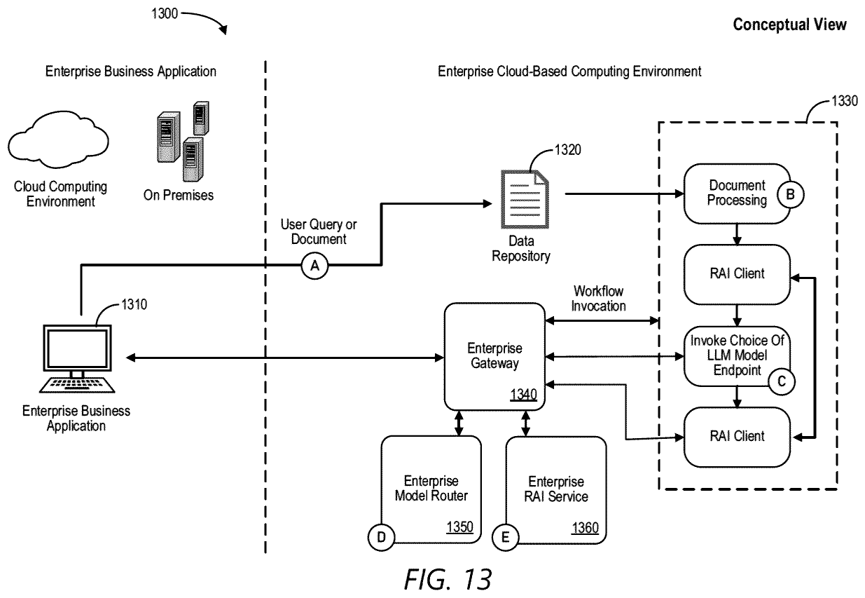

A feedback loop 1250 may provide detailed error messages when the validation fails. This helps the application team understand what needs to be fixed in the workflow JSON. Automated rollback 1260 may, in the case of a validation failure during deployment, have an automated rollback mechanism to revert to the last known good state of the workflow. Monitoring and alerts 1270: may monitor the validation process and set up alerts to notify the appropriate personnel when a validation failure occurs. Documentation 1280 may provide clear documentation about how to use the schema for validation, including examples of valid and invalid workflow modifications. Finally, training 1290 may offer sessions for application teams to familiarize them with the validation process and the importance of adhering to the schema. By following these steps, a robust validation process can be created that ensures the integrity of GenAI workflows and maintains a platform's standards and best practices. FIG. 13 is a conceptual view of an enterprise reference architecture 900 according to some embodiments. The architecture 1300 includes an enterprise business application (e.g., in a cloud computing environment or an on-premises system) and enterprise cloud computing environment components. At (A), an enterprise business application 1310 uploads user query text or a document to a document or data repository 1320 (such as AWS S3) for processing. At (B), document loader module in a customized workflow 1330 will process and prepare payload and chunk or split data for better processing. At (C), LLM endpoints are preconfigured on Advanced Programmable Interrupt Controller (“APIC”) and communicated to an enterprise gateway 1340 (e.g., an AWS API gateway). As per a decision made in an enterprise model router 1350 (e.g., an LLM and prompt configuration repository), a model connector invokes the APIC endpoint to invoke the LLM. The system formats the response generated by LLM endpoint to a desired response structure with associated reference article and/or image links and returns it to a user. At (D), the enterprise model router 1350 identifies the appropriate model, its endpoint, and the LLM prompt for a desired use case. The model router 1350 fetches the model's name and details about that model from LLM configuration repository, finds an appropriate LLM prompt from the prompt library and hands over control to the model connector thus invoking an LLM call. At (E), an enterprise Responsible AI (“RAI”) service 1360 applies applicable responsible AI controls. All requests to the LLM and responses from the LLM are sent to the enterprise RAI service 1360 to detect and act against unwanted content.

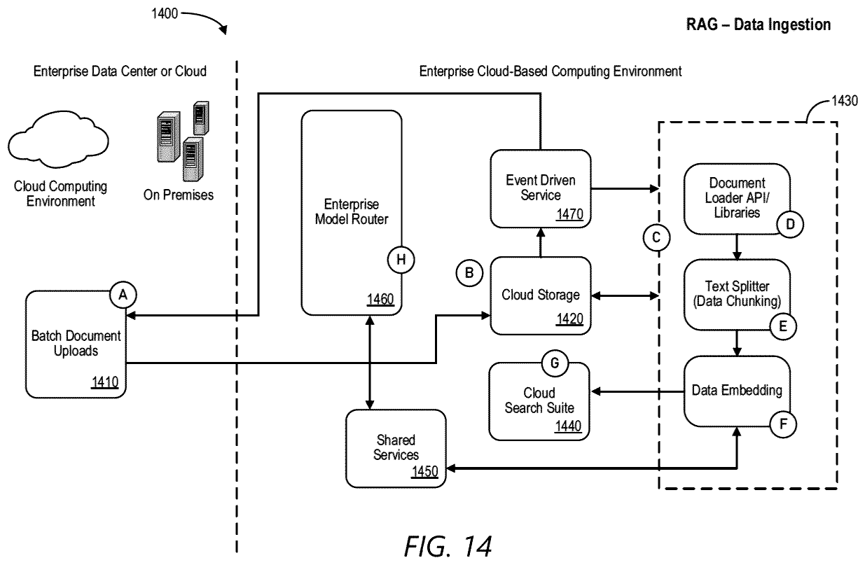

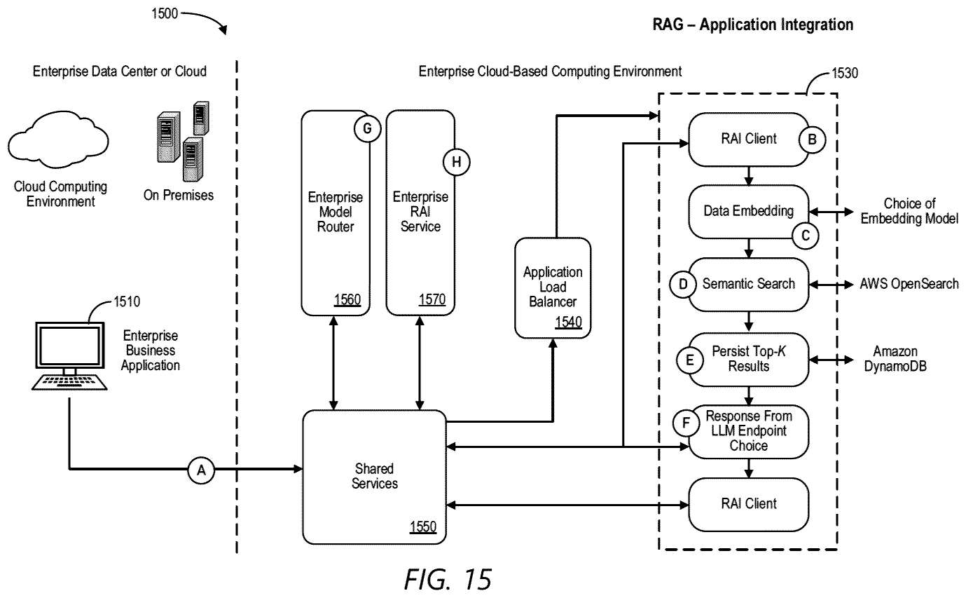

According to some embodiments, a Gmini-platform may be associated with domain specific RAG and/or chatbot. FIGS. 14 and 15 are some RAG frameworks in accordance with various embodiments. In particular, FIG. 14 is a RAG framework 1400 for a data ingestion implementation in accordance with some embodiments. At (A) and (B), when a substantial number of documents require processing, the documents may be uploaded from batch document uploads 1410 to cloud storage 1420 (such as AWS S3) using enterprise architecture “ingestion” patterns. After a document is uploaded to cloud storage 1420, an event would trigger a workflow 1430 using any “suitable” Enterprise Data Architecture (“EDA”) pattern. The requester may be informed when the document has been processed via an event-driven mechanism.

At (C), in a state machine the system can use resources to run an ECS task and wait for it to complete. If the system wants to process multiple documents in parallel, it may use the parallel state in the workflow 1430. This lets multiple branches of the state machine execute concurrently. At (D), the workflow 1430 provides an agnostic document loaders module to integrate with the cloud storage 1420. The system may configure a client by passing named arguments when creating a directory loader allowing it to process all documents from respective folders in parallel. Embodiments might also use AWS Textract instead of LangChain's base module. At (E), after loading documents the workflow 1430 may chunk a lengthy document into smaller parts to fit within a model's context window. LangChain has multiple built-in document transformers that make it easy to split, combine, filter, and otherwise manipulate documents. At (F), an embeddings class is a tool that provides a unified interface for interacting with various text embedding models from different providers such as AWS, Azure, OpenAI, Cohere, and Hugging Face.

At (G), embedded data may be persisted in a cloud search suite 1440 such as the AWS OpenSearch collection. Embeddings can be communicated to shared services 1450 and/or stored or temporarily cached to avoid the need to recompute them. The tool that provides caching of embeddings may wrap around an embedder and store embeddings in a key-value cache (using a hash of the text as the key). At (H), an enterprise model router 1460 fetches the model's name and details about that model from an LLM configuration repository, finds an appropriate LLM prompt from a prompt library and hands over control to a model connector thus invoking an LLM call. An event driven service 1470 may communicate with the batch document uploads when processing is complete.

FIG. 15 is a RAG framework 1500 for an application integration implementation in accordance with some embodiments. At (A), a user submits a query or question via a web or enterprise business application 1510. The client makes an HTTP POST request to the APIC endpoint via shared services 1550 which will invoke the workflow 1530 through an application load balancer 1540 and a choice of orchestration. At (B), a RAI client and enterprise RAI service 1570 helps ensure that AI systems are designed, developed, and deployed in a manner that upholds principles such as fairness, transparency, accountability, and privacy. At (C), a user payload may be passed to an embedding model endpoint to get data embedding. Some embodiments may use an open-source embedding model via an enterprise code repository.

At (D), with the embedded data the workflow 1530 can run a semantic search using a vectorized question to retrieve the top-k best matches from vector storage. At (E), the workflow 1530 may build prompt context using the returned top-k matched data chunks and a prompt template for enterprise to make a call to the appropriate LLM endpoint. At (F), the workflow 1530 may format the response generated by the LLM endpoint to a desired response structure with associated reference article and/or image links to be returned to the user. A user may customize the workflow 1530 via a UI. For example, the user might access several different “Semantic Search” components in a function library. The user can then replace the current “Semantic Search” component with a new one. Similarly, the user might delete components, add new components to the workflow 1530. When the changes are complete, the user may save the new, customized workflow (e.g., for recycling by other users). At (G), an enterprise model router 1560 also exposes the service to get details about the configured model (e.g., details for a given use case).

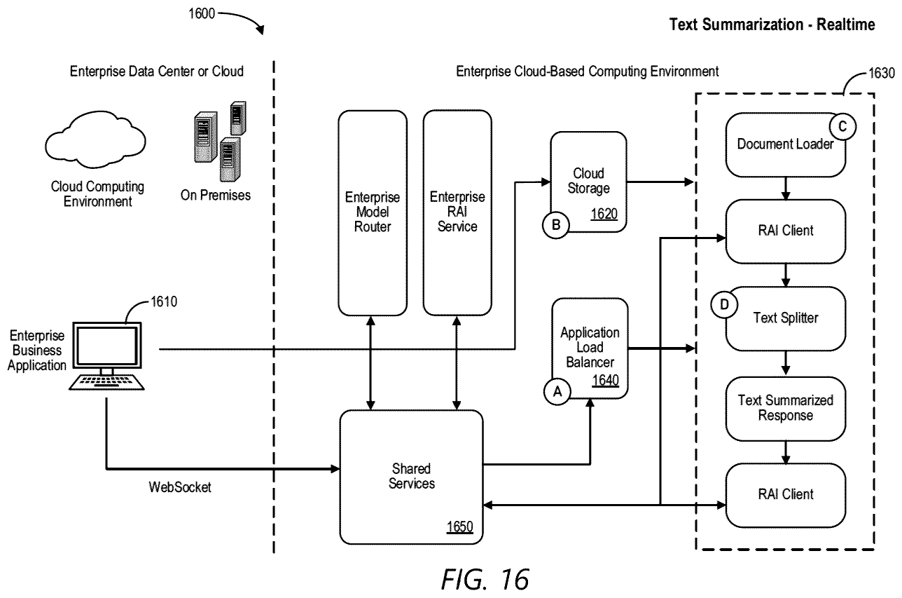

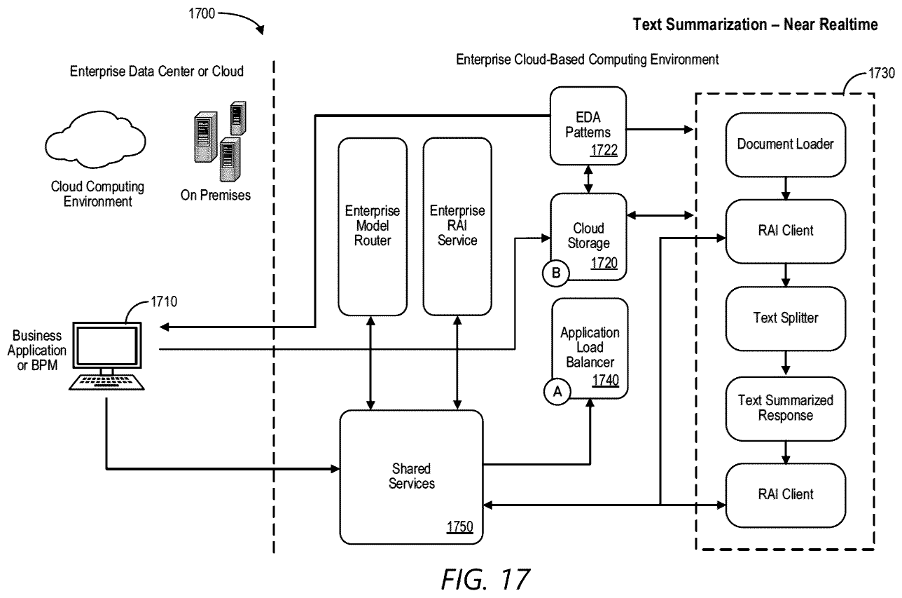

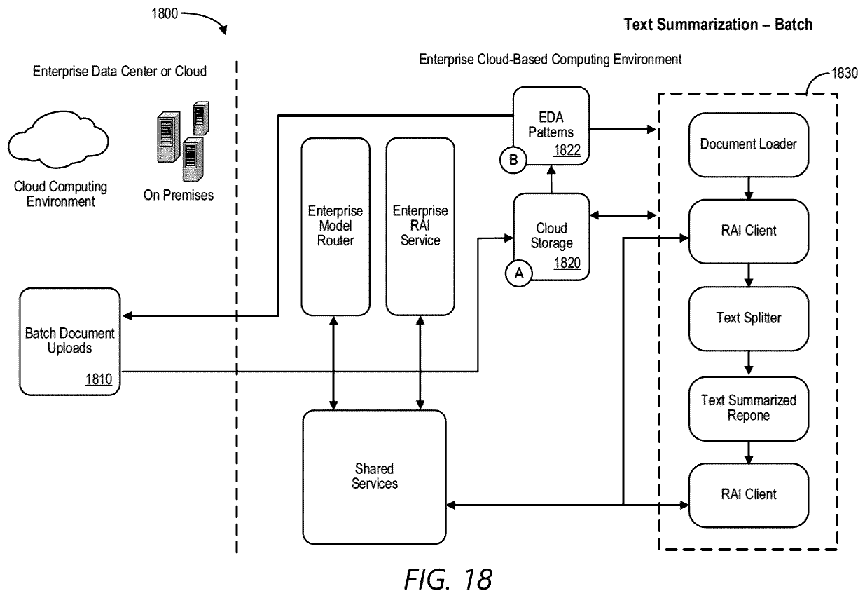

FIG. 16 through 18 are some text summarization frameworks according to various embodiments. In particular, FIG. 16 is a text summarization framework 1600 for a realtime implementation in accordance with some embodiments. At (A) and (B), an enterprise business application 1610 calls an API requesting a document upload via an application load balancer 1640 where the API response payload contains a pre-signed one-time-use URL for cloud storage 1620 document upload. The user initiates the process for text summarization by invoking an API exposed by APIC via shared services 1650. Teams can also use AWS IAM roles for AWS clients. At (C), LangChain stages in a customized workflow 1630 includes an agnostic document loader module to integrate with the cloud storage 1620. Embodiments may configure a client by passing named arguments. This lets the workflow 1630 process all documents from respective folders in parallel. At (D), embodiments may chunk a lengthy document into smaller parts to fit within a model's context window. Note that LangChain has multiple built-in document transformers that make it easy to split, combine, filter, and otherwise manipulate documents. FIG. 17 is a text summarization framework 1700 for a near realtime implementation in accordance with some embodiments. At (A) and (B), a business application or Business Process Model (“BPM”) 1710 calls an API requesting a document upload where the API response payload contains a pre-signed one-time-use URL created by an application load balancer 1740 for a cloud storage 1720 document upload. Embodiments may also use shared services 1750 roles for clients. Once the document is uploaded, an event may trigger a customized workflow 1730 using any “suitable” enterprise architecture EDA pattern 1722. Note that the requester may be informed after the document has been processed via an event driven mechanism. FIG. 18 is a text summarization framework 1800 for a batch implementation in accordance with some embodiments. At (A) and (B), when a substantial number of documents are to be processed, documents may be uploaded from batch document uploads 1810 to cloud storage 1820 using enterprise architecture “ingestion” patterns. Once the documents are uploaded, an event may trigger a customized workflow 1830 using any “suitable” enterprise architecture EDA patterns 1822. Note that a requester may be informed after a document has been processed via an event driven mechanism.

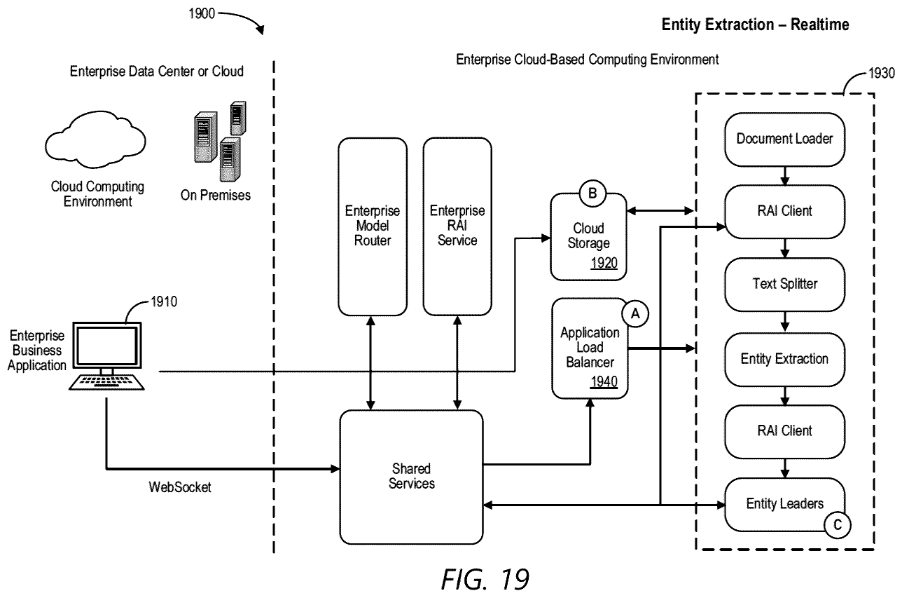

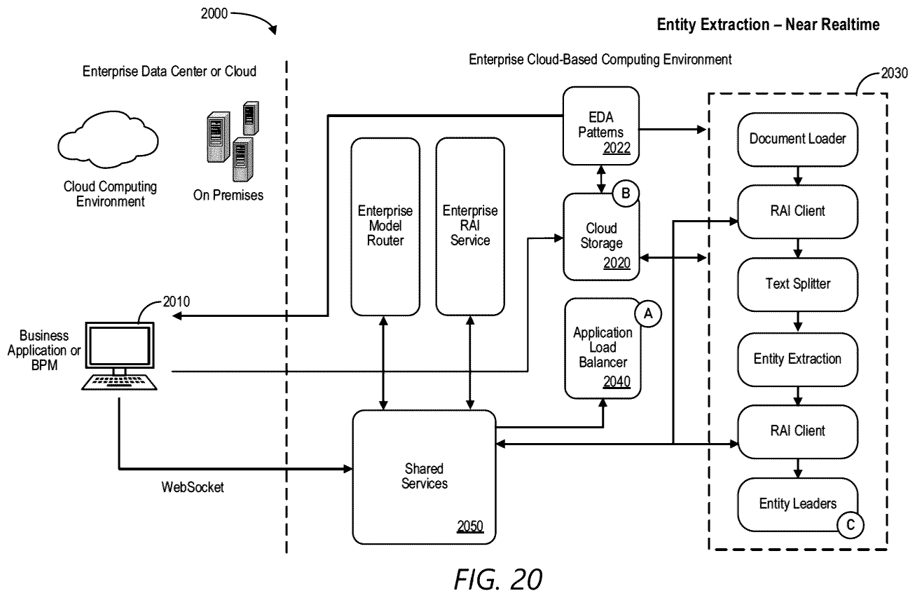

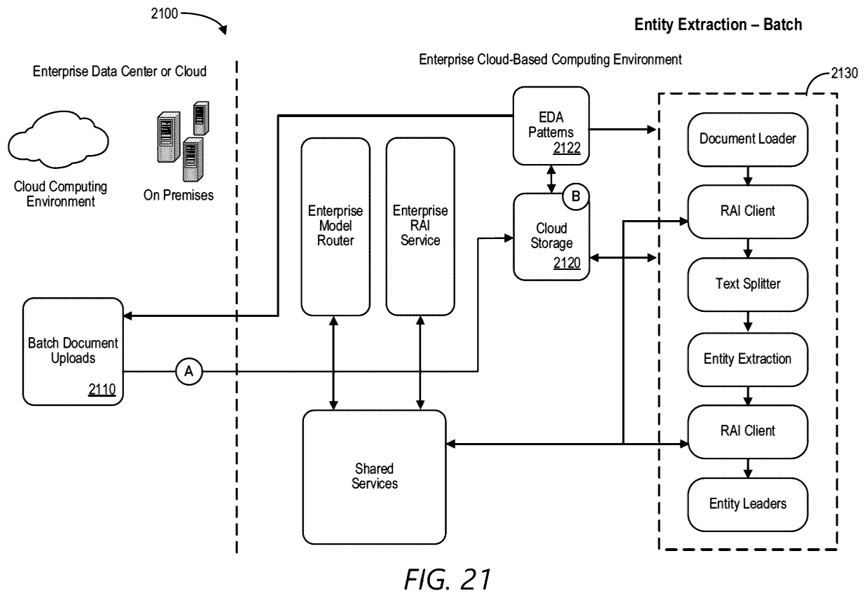

FIGS. 19 through 21 are some entity extraction frameworks in accordance with various embodiments. In particular, FIG. 19 is an entity extraction framework 1900 for a realtime implementation in accordance with some embodiments. At (A), an application calls an API (e.g., via an application load balancer 1940) requesting a document upload. The API response payload may contain, for example, a pre-signed one-time use URL for a document upload. A user may initiate the process for entity extraction by invoking an API exposed by APIC (or AWS Identity and Access Management (“IAM”) roles). An enterprise business application 1910 executing in a data center or cloud may then upload a document to cloud storage 1920 at (B). At (C), an optional step in a workflow 1930 may be responsible for building graph database insert statements. This step may be, for example, invoked based on the configuration maintained for the use case (and represent the entity relationship in knowledge graph). FIG. 20 is an entity extraction framework 2000 for a near realtime implementation in accordance with some embodiments. At (A), an enterprise application or BPM 2010 calls an API requesting a document upload (e.g., via an application load balancer 2040 and shared services 2050), and the API response payload may contain a pre-signed one time-use URL for a document upload to cloud storage 2020. Once the document is uploaded at (B), an event triggers a Stepfuntion workflow 1630 using any “suitable” enterprise architecture EDA pattern 2022. Note that the requester should be informed once the document has been processed via an event driven mechanism. FIG. 21 is an entity extraction framework 2100 for a batch implementation in accordance with some embodiments. At (A), when a substantial number of documents are to be processed, documents may be uploaded 2110 to cloud storage 2120 using enterprise architecture “ingestion” patterns at (B). Once the document is uploaded, an event may trigger a workflow 2130 using any “suitable” enterprise architecture EDA pattern 2122. The requester may then be informed after the document has been processed via an event driven mechanism.

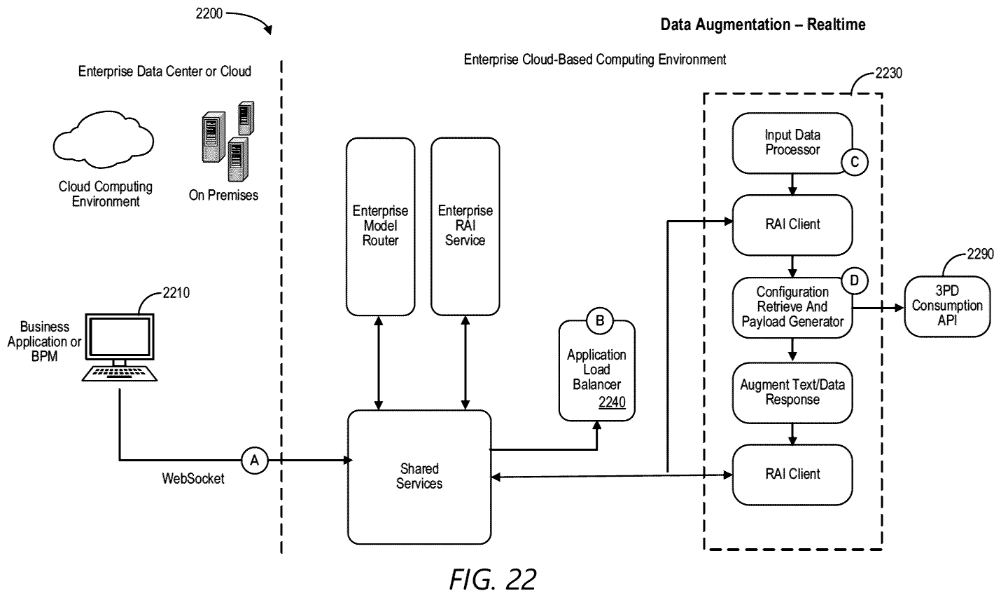

FIG. 22 is a realtime data augmentation framework 2200 according to some embodiments. At (A), a user may execute a business application or BPM 2210 to initiate a process for data augmentation by invoking an API exposed by APIC via an application load balancer 2240 at (B). The input data is expected to have text along with the entities in a JSON format (e.g., a pre-approved JSON template) which will help the system understand which entities should be augmented. At (C), this service parses the input received in text and JSON format and identifies the entities to be augmented by a workflow 2230 (e.g., for consumption by a third-party data API 2290). At (D), this service is responsible for identifying the third-party data service responsible for getting more details of an entity to be augmented (e.g., from a “source mapping and configurations repository”.) It also provides information about the service endpoints, protocol, port, etc. Once all service details are retrieved from “source mapping and configurations repository,” the service continues with the generation of a payload for further processing.

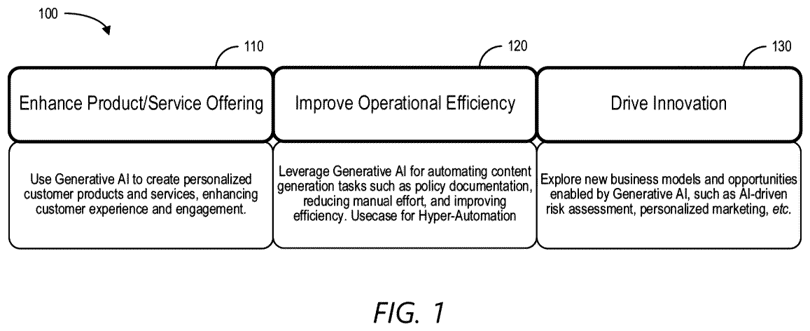

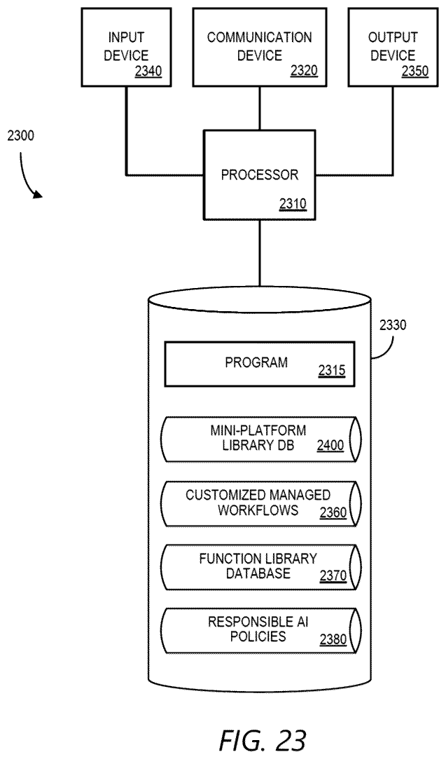

The embodiments described herein may be implemented using any number of different hardware configurations. For example, FIG. 23 illustrates an apparatus 2300 that may be, for example, associated with the system 100 described with respect to FIG. 1 (or any other system described herein). The apparatus 2300 comprises a processor 2310, such as one or more commercially available Central Processing Units (“CPUs”) in the form of one-chip microprocessors, coupled to a communication device 2320 configured to communicate via a communication network (not shown in FIG. 23). The communication device 2320 may be used to communicate, for example, with one or more remote third-party devices, users, business applications, and/or communication devices (e.g., PCs and smartphones). Note that communications exchanged via the communication device 2320 may utilize security features, such as those between a public internet user and an internal network of an insurance company and/or an enterprise. The security features might be associated with, for example, web servers, firewalls, and/or PCI infrastructure. The apparatus 2300 further includes an input device 2340 (e.g., a mouse and/or keyboard to enter information about workflow customization, EDA patterns, system mappings, communication addresses, etc.) and an output device 2350 (e.g., to output reports regarding mini-platforms, recommendations, alerts, etc.).

The processor 2310 also communicates with a storage device 2330. The storage device 2330 may comprise any appropriate information storage device, including combinations of magnetic storage devices (e.g., a hard disk drive), optical storage devices, mobile telephones, and/or semiconductor memory devices. The storage device 2330 stores a program 2315 and/or mini-platform GenAI tool or application for controlling the processor 2310. The processor 2310 performs instructions of the program 2315, and thereby operates in accordance with any of the embodiments described herein. For example, the processor 2310 may execute LLMs. A plurality of active enterprise mini-platforms may each be based on a potential generative AI mini-platform and have a customized managed workflow associated with an enterprise use case. The processor 2310 may facilitate model routing and orchestration to support the LLMs. The processor 2310 may also interface between the cloud-based generative AI operational environment and the plurality of active enterprise mini-platforms to provide access to enterprise data that is processed via the customized managed workflows.

The program 2315 may be stored in a compressed, uncompiled and/or encrypted format. The program 2315 may furthermore include other program elements, such as an operating system, a database management system, and/or device drivers used by the processor 2310 to interface with peripheral devices.

As used herein, information may be “received” by or “transmitted” to, for example: (i) the apparatus 2300 from another device; or (ii) a software application or module within the apparatus 2300 from another software application, module, or any other source.

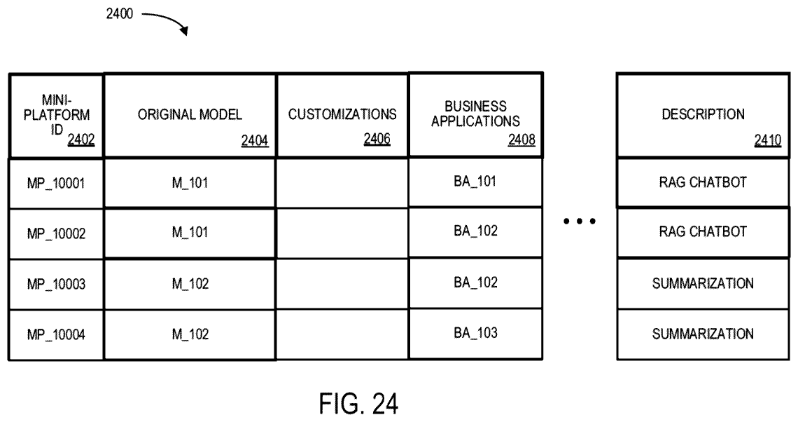

In some embodiments (such as shown in FIG. 23), the storage device 2330 further includes a mini-platform library database 2400, customized managed workflows 2360, a function library database 2370, and responsible AI policies 2380. An example of a database that might be used in connection with the apparatus 2300 will now be described in detail with respect to FIG. 24. Note that the database described herein is only an example, and additional and/or different information may be stored therein. Moreover, various databases might be split or combined in accordance with any of the embodiments described herein. For example, the customized managed workflows 2360 and responsible AI policies 2380 might be combined and/or linked to each other within the program 2315.

Referring to FIG. 24, a table is shown that represents the mini-platform library database 2400 that may be stored at the apparatus 2300 according to some embodiments. The table may include, for example, entries associated with

GenAI mini-platforms that may be utilized by an enterprise. The table may also define fields 2402, 2404, 2406, 2408, 2410 for each of the entries. The fields 2402, 2404, 2406, 2408, 2410 may, according to some embodiments, specify: a mini-platform identifier 2402, an original model 2404, customizations 2406, business applications 2408, and a description 2410. The mini-platform library database 2400 may be created and updated, for example, when a new GenAI use case is created or an existing use case is updated in connection with an insurer or business.

The mini-platform identifier 2402 may be, for example, a unique alphanumeric code identifying a GenAI model associated with a LLM (e.g., for an RAG chatbot, summarization, stylization, data extraction, etc.). The original model 2404 may comprise a template on which the GenAI model is based. The customizations 2406 may represent a workflow that has been modified for a particular use case. The business applications 2408 might represent enterprise programs that utilize the GenAI model. The description 2410 might indicate, for example, that the GenAI model is associated with an AI assistant, data augmentation, translation, classification, etc.

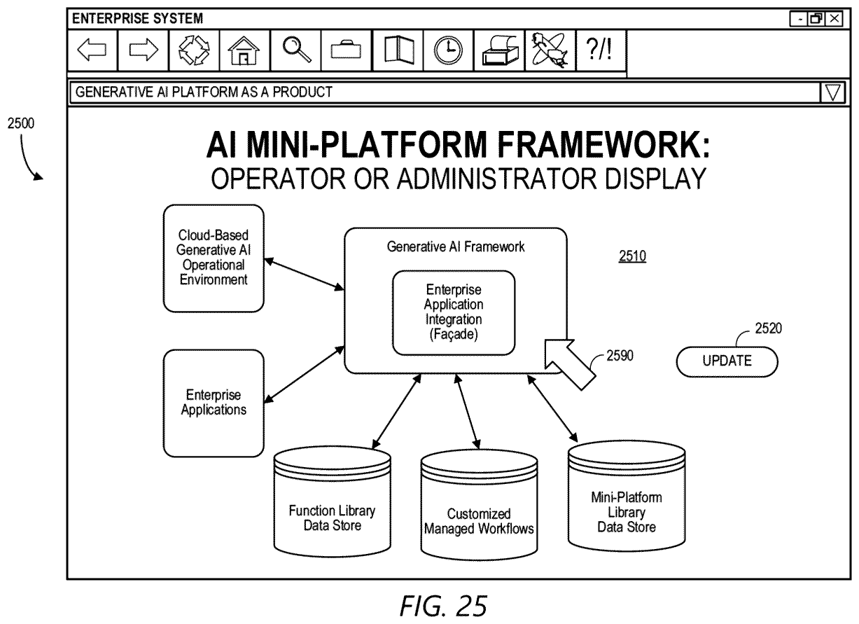

The operation of the enterprise risk relationship analysis system may be controlled via a Graphical User Interface (“GUI”). For example, FIG. 25 is an AI mini-platform framework operator or administrator display 2500 including graphical representations of elements of such a tool 2510 according to some embodiments. Selection of a portion or element of the display 2500 via a touchscreen or computer mouse pointer 2590 might result in the presentation of additional information about that portion or element (e.g., a popup window presenting data mappings, customized workflows, etc.) or let an operator or administrator enter or annotate additional information about a mini-platform or use case (e.g., based on his or her experience and expertise). An “Update” icon 2520 might initiate an enterprise mini-platform process.

Thus, embodiments may provide improved systems and methods to accurately and/or automatically implement generative AI models for an enterprise. Plug-and-play integration with a framework may be provided using a well-defined interface (e.g., real-time, near real time, or batch). The flexibility to allow for the customization and enhancement of components of a mini-platform (e.g., stages of a workflow) may help ensure that solutions built using the framework are both robust and adaptable to the evolving customer needs.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of insurance, embodiments may instead be associated with other types of insurance in addition to and/or instead of those described herein. Similarly, although certain types of insurance, businesses, and organization parameters were described in connection with some embodiments herein, other types of arrangements and configurations might be used instead.

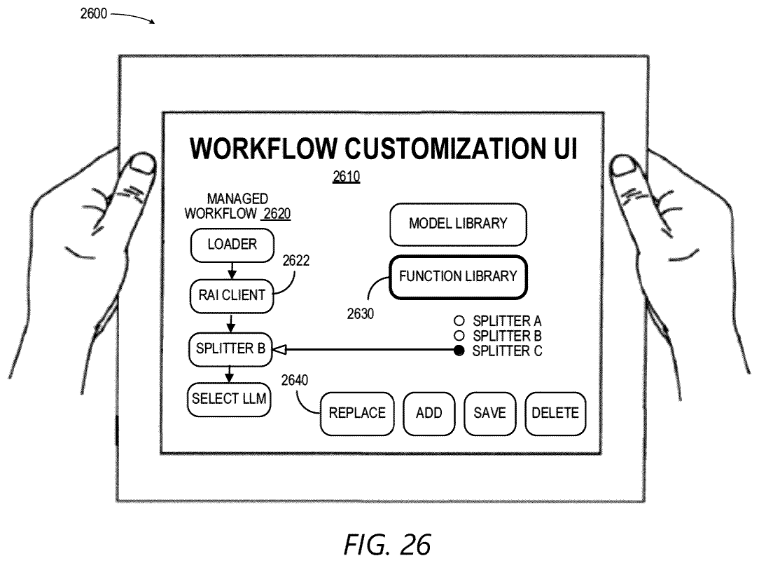

FIG. 26 illustrates a handheld tablet 2600 displaying a workflow customization UI 2610 in accordance with some embodiments. The UI 2610 includes a graphical interface that a user may utilize to customize a managed workflow for a mini-platform. In particular, the US 2610 shows a managed workflow 2620 comprising a series of components or functions 2622 wired together to define operation of the mini-platform. Although the workflow 2620 illustrated in FIG. 26 is linear in nature (e.g., a document loader followed by an RAI client followed by text splitter B, etc.), embodiments are not so limited and might include, for example, parallel components, decision points, etc. a user may select a model library (e.g., to load a pre-defined or previously customized managed workflow 2620. The user may also select a function library 2630, resulting in the display of various components (e.g., splitter A, splitter B, and splitter C). The user may then select a component 2622 in the current workflow 2620 and replace 2640 it with selected function (e.g., replacing “splitter B” with “splitter C” as illustrated in FIG. 26). The user might also add components 2622 (e.g., extending the workflow 2620), save a customized workflow 2620, delete a component 2622 or workflow 2620, etc. The UI 2610 might be used, for example, to improve use case customizations for GenAI mini-platforms of an enterprise. Note that embodiments might be associated with any type of business (e.g., insurance companies, financial enterprises, educational institutions, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A generative Artificial Intelligence (“AI”) framework system for an enterprise, comprising:
a cloud-based generative AI operational environment to execute Large Language Models (“LLMs”);
a mini-platform library data store that contains electronic records associated with a plurality of potential generative AI mini-platforms, and, for each potential generative AI mini-platform, a mini-platform identifier and at least one mini-platform parameter;
a workflow function library data store that contains functions usable to customize managed workflows for the enterprise;
a plurality of active enterprise mini-platforms, each active enterprise mini-platform being based on a potential generative AI mini-platform and having a customized managed workflow for an enterprise use case; and
an enterprise application integration component coupled to the cloud-based generative AI operational environment and the plurality of active enterprise mini-platforms, including:
a computer processor, and
a computer memory coupled to the computer processor and storing instructions that, when executed by the computer processor, cause the enterprise application integration component to:
facilitate model routing and orchestration to support the LLMs, and
interface between the cloud-based generative AI operational environment and the plurality of active enterprise mini-platforms to access enterprise data that is processed via customized managed workflows.

2. The system of claim 1, wherein a customized managed workflow comprises a series of Python framework stages.

3. The system of claim 1, further comprising:
a responsible AI component to enforce AI controls both pre-and post-LLM execution.

4. The system of claim 1, wherein the mini-platform library data store includes both pre-trained foundational models and user customized models.

5. The system of claim 4, wherein at least one active enterprise mini-platform is associated with at least one of: (i) Retrieval-Augmented Generation (“RAG”), (ii) summarization, (iii) stylization, (iv) data extraction, (v) an AI assistant, (vi) data augmentation, (vii) translation, and (viii) classification.

6. The system of claim 1, wherein the workflow function library data store includes both pre-defined functions and user customized functions.

7. The system of claim 1, further comprising:
a security component to enforce data encryption, authentication, and authorizations.

8. The system of claim 1, further comprising:
a prompt management component between the plurality of active enterprise mini-platforms and the enterprise application integration component to enable prompt engineering.

9. The system of claim 1, further comprising:
a plurality of business applications; and
a core data and AI foundation component, coupled between the enterprise application integration component and the plurality of business applications, to acquire, curate, disseminate, manage, and govern domain data for workflow consumption.

10. The system of claim 1, wherein the enterprise is associated with risk relationships.

11. The system of claim 10, wherein the enterprise comprises an insurer and at least one use case is associated with at least one of: (i) regulation/compliance filing assistance, (ii) an enhanced customer-facing chatbot, (iii) personalized marketing communications creation, (iv) insurance policy summarization, (v) personalized messages and recommendations, (vi) competitive intelligence report generation, (vii) data augmentation for actuarial pricing, (viii) an agent recommendation generation engine, (ix) a voice input for claims First Notice of Loss (“FNOL”), (x) product summarization for product design, (xi) a conversational solution configuration, (xii) a knowledge worker conversational User Interface (“UI”) for core systems, (xiii) code generation, (xiv) underwriting risk analysis and summary, (xv) fraud rule generation, (xvi) a knowledge worker chatbot, and (xvii) legacy code conversion assistance.

12. A generative Artificial Intelligence (“AI”) framework method for an enterprise, comprising:
facilitating, by a computer processor of an enterprise application integration component, model routing and orchestration to support Large Language Models (“LLMs”);
interfacing, by the enterprise application integration component, between a cloud-based generative AI operational environment and a plurality of active enterprise mini-platforms providing access to enterprise data that is processed via customized managed workflows; and
executing the LLMs in a cloud-based generative AI operational environment,
wherein a mini-platform library data store contains electronic records associated with a plurality of potential generative AI mini-platforms, and, for each potential generative AI mini-platform, a mini-platform identifier and at least one mini-platform parameter,
wherein a workflow function library data store contains functions usable to customize managed workflows for the enterprise, and
further wherein each of the plurality of active enterprise mini-platforms is based on a potential generative AI mini-platform and has a customized managed workflow associated with an enterprise use case.

13. The method of claim 11, further comprising:
enforcing, by a responsible AI component, both pre-and post-LLM execution controls.

14. The method of claim 11, wherein the mini-platform library data store includes both pre-trained foundational models and customized models.

15. The method of claim 14, wherein at least one active enterprise mini-platform is associated with at least one of: (i) Retrieval-Augmented Generation (“RAG”), (ii) summarization, (iii) stylization, (iv) data extraction, (v) an AI assistant, (vi) data augmentation, (vii) translation, and (viii) classification.

16. The method of claim 11, further comprising:
enforcing, by a security component, data encryption, authentication, and authorizations.

17. The method of claim 11, further comprising:
enabling prompt engineering by a prompt management component between the plurality of active enterprise mini-platforms and the enterprise application integration component.

18. The method of claim 11, further comprising:
acquiring, curating, disseminating, managing, and governing, by a core data and AI foundation component coupled between the enterprise application integration component and a plurality of business applications, domain data for workflow consumption.

19. The method of claim 11, wherein the enterprise is associated with risk relationships.

20. The method of claim 19, wherein the enterprise comprises an insurer and at least one use case is associated with at least one of: (i) regulation/compliance filing assistance, (ii) an enhanced customer-facing chatbot, (iii) personalized marketing communications creation, (iv) insurance policy summarization, (v) personalized messages and recommendations, (vi) competitive intelligence report generation, (vii) data augmentation for actuarial pricing, (viii) an agent recommendation generation engine, (ix) a voice input for claims First Notice of Loss (“FNOL”), (x) product summarization for product design, (xi) a conversational solution configuration, (xii) a knowledge worker conversational User Interface (“UI”) for core systems, (xiii) code generation, (xiv) underwriting risk analysis and summary, (xv) fraud rule generation, (xvi) a knowledge worker chatbot, and (xvii) legacy code conversion assistance.
